(19) United States
(12) Patent Application Publication
(10) Pub. No.: US 2015/0072139 A1
(43) Pub. Date: Mar. 12, 2015

(54) Release Film, Compression Molding Method, And Compression Molding Apparatus

(71) Applicant: Dow Corning Toray Co., Ltd, Tokyo (JP)

(72) Inventors: Yoshitsugu Morita, Ichihara-shi (JP); Shin Yoshida, Ichihara-shi (JP); Syuji Endo, Ichihara-shi (JP)

(73) Assignee: Dow Corning Toray Co., Ltd, Tokyo (JP)

(21) Appl. No.: 14/396,890

(22) PCT Filed: Apr. 23, 2013
(86) PCT No.: PCT/JP2013/062686

§ 371 Date: Oct. 24, 2014

(30) Foreign Application Priority Data
Apr. 27, 2012 (JP) 2012-104071

(51) Int. Cl. B29C 33/68; B29C 43/50

(52) U.S. Cl. CPC B29C 33/68; B29C 43/50; B29K 2883/005
USPC 428/338; 264/319; 425/89; 525/478; 525/476; 428/447; 428/412

(57) ABSTRACT

The present invention relates to a release film used by being interposed between a molding material and a mold when the molding material is compression molded using the mold in order to form a sealing material or reflective frame material for an optical semiconductor element, or a lens, wherein the release film comprises a silicone-based cured product layer (2) on at least a surface in contact with the molding material; as well as a compression molding method that uses the film; and a compression molding apparatus that uses the film. The release film for the compression molding of molding materials has good workability and has good releasability, and thereby, a compression molding method with which compression molding with good efficiency is possible and a compression molding apparatus with which molding with good efficiency is possible.

### TECHNICAL FIELD

The present invention relates to a release film, a compression molding method that uses the film, and a compression molding apparatus that uses the film.

Priority is claimed on Japanese Patent Application No. 2012-104071, filed on Apr. 27, 2012, the content of which is incorporated herein by reference.

### BACKGROUND ART

Methods for molding a sealing material for an optical semiconductor element, or methods for molding a reflective frame for an optical semiconductor element and further, methods for molding a lens, by compression molding a molding material using a mold are well known (refer to Japanese Unexamined Patent Application Publication Nos. 2005-305954, 2006-093354, 2006-148147 and 2008-227119). In these methods, a release film is used because releasability of a molded product from a mold is improved and burrs can be reduced. Fluorine resin films, such as polytetrafluoroethylene resin (PTFE) film, ethylene-tetrafluoroethylene copolymer resin (ETFE) film, tetrafluoroethylene-perfluoropropylene copolymer resin (FEP) film, and polyvinylidene fluoride resin film, as well as polyethylene terephthalate resin (PET) film and polypropylene resin (PP) film are used as this release film.

However, polytetrafluoroethylene resin (PTFE) film and ethylene-tetrafluoroethylene copolymer resin (ETFE) film are problematic in that although they have good molded product releasability, they have low strength and, as release films, are difficult to handle at molding temperatures. There is another problem in that there are difficulties associated with the waste treatment and recycling of used polytetrafluoroethylene resin (PTFE) film and ethylene-tetrafluoroethylene copolymer resin (ETFE) film.

On the other hand, although polyethylene terephthalate resin (PET) film and polypropylene resin (PP) film have good workability and can be easily disposed of after use, they are problematic in that molded product releasability is insufficient.

An object of the present invention is to provide a release film for compression molding of molding materials that has good workability and has good releasability. A further object of the present invention is to provide a compression molding method with which compression molding with good efficiency is possible. A further object of the present invention is to provide a compression molding apparatus with which molding with good efficiency is possible.

### DISCLOSURE OF INVENTION

The release film of the present invention is a release film used by being interposed between a molding material and a mold when the molding material is compression molded using the mold in order to form a sealing material or reflective frame material for an optical semiconductor element, or a lens. The release film comprises a silicone-based cured product layer on at least a surface in contact with the molding material.

The compression molding method of the present invention is a method for compression molding a sealing material or reflective frame material of an optical semiconductor element, or a lens, by feeding a release film between a top mold and a bottom mold and then feeding a molding material, characterized in that the above-mentioned release film is used as the release film.

Moreover, the compression molding apparatus of the present invention is a compression molding apparatus for molding a sealing material or reflective frame material of an optical semiconductor element, or a lens, that comprises at least a top mold, a bottom mold, a release film feed mechanism and a molding material feed mechanism, the compression molding apparatus uses the above-mentioned release film as the release film fed to inside the mold by the release film feed mechanism.

### Effects of Invention

The release film of the present invention is a release film that is used for compression molding of molding materials, and has good workability and good releasability of a molded product. Moreover, the compression molding method of the present invention is characterized in that molding with good efficiency is possible. Furthermore, the compression molding apparatus of the present invention is characterized in that molding with good efficiency is possible.

### BRIEF DESCRIPTION OF THE DRAWINGS

FIG. 1 is a cross-sectional drawing of the release film of the present invention.

FIG. 2 is a cross-sectional drawing of another release film of the present invention.

FIG. 3 is a cross-sectional drawing of a partially broken view showing the release film fed between a top mold and a bottom mold.

FIG. 4 is a cross-sectional drawing of a partially broken view showing a molding material that has been fed.

FIG. 5 is a cross-sectional drawing of a partially broken view showing the molding material that has been compression molded.

FIG. 6 is a cross-sectional drawing of a partially broken view showing the release film fed between a top mold and a bottom mold.

FIG. 7 is a cross-sectional drawing of a partially broken view showing a molding material that has been fed.

FIG. 8 is a cross-sectional drawing of a partially broken view showing the molding material that has been compression molded.

FIG. 9 is a cross-sectional drawing of a partially broken view of an optical semiconductor element molded together with a lens as a single unit.

FIG. 10 is a cross-sectional drawing of a partially broken view of another optical semiconductor element molded together with a lens as a single unit.

### DETAILED DESCRIPTION OF THE INVENTION

First, the release film of the present invention will be described in detail.

The release film of the present invention is used by being interposed between a molding material and a mold when a molding material for molding the sealing material or reflective frame material of an optical semiconductor element, or a lens, is compression molded using a mold.

A light emitting diode (LED) chip is an example of a semiconductor element that can be compression molded using the release film of the present invention. Preferably, the LED chip is one wherein a semiconductor such as InN, AlN, GaN, ZnSe, ZnO, SiC, GaP, GaAs, GaAlAs, GaAlN, AlInGaP, InGaN, or AlInGaN has been formed as a light emitting layer on a substrate by the liquid phase growth method or MOCVD method.

Moreover, silicone-based materials, silicone-modified epoxy resin-based materials, and epoxy resin-based materials are examples of the molding material that can be compression molded using the release film of the present invention. Examples of silicone-based materials are addition reaction curable silicone compositions, condensation reaction curable silicone compositions, and peroxide curable silicone compositions, and addition reaction curable silicone compositions are preferable. The addition reaction curable silicone composition can be obtained as Dow Corning (registered trademark) OE-6636, OE-6662, OE-6370HF, EG-6301, JCR6125, and the like from Dow Corning Toray Co., Ltd.

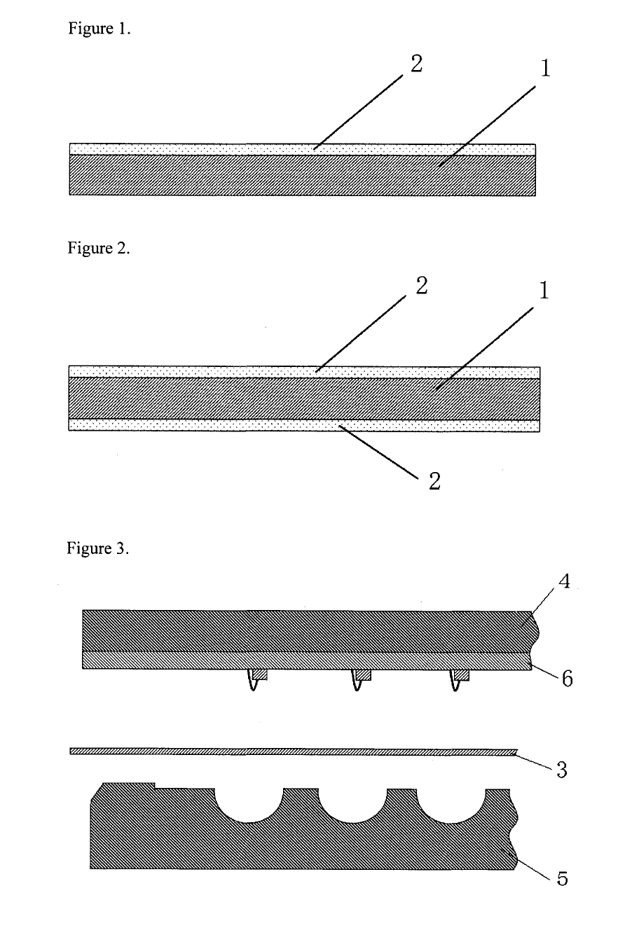

The release film of the present invention has a silicone-based cured product layer on at least a surface that will contact the molding material. FIG. 1 is an embodiment of the invention of the present application where there is a silicone-based cured product layer 2 on one surface of a base film 1. Moreover, FIG. 2 is another embodiment of the invention of the present application where there is a silicone-based cured product layer 2 on both sides of a base film 1. Although the release film having silicone-based cured product layers on both surfaces such as shown in FIG. 2 is expensive when compared to a film having a silicone-based cured product layer on one surface only, it promises to alleviate impact with the molded product during compression molding and improve bonding and the ability of the release film to follow the mold while improving releasability of the release film from the mold.

Preferably, the release film of the present invention has heat resistance at the molding temperature of the molding material during compression molding, and has flexibility to the extent that it can adhere closely to the mold. Examples of the base film of such a release film are polyolefin, polybutylene terephthalate, polyethylene terephthalate, polyamide, polycarbonate, polyvinylidene chloride, polystyrene, polyvinyl alcohol, polyimide, and mixtures thereof. The thickness of the base film is not particularly limited, but preferably is within a range of 10 to 100 μm. This is because when thickness is 10 μm or greater, the film will not be easily tone during compression molding, while when film thickness is 100 μm or less, the ability to follow the mold and flexibility are improved. Note that the surface of the base film can be plasma treated or primer treated in advance in order to improve bonding with the silicone cured product layer.

Moreover, the silicone-based cured product layer is one formed by curing a curable silicone-based composition. Examples of the curable silicone-based composition are compositions that are addition reaction curable, condensation reaction curable, peroxide curable, high-energy beam curable, curable by addition reaction and condensation reaction, curable by addition reaction and high-energy beams, or curable by condensation reaction and high-energy beams. Depending on the coating mode, the composition can be a solvent composition, a solvent-free composition, or an emulsion composition.

An example of an addition reaction curable composition is one comprising: an organopolysiloxane having at least two alkenyl groups in one molecule, an organopolysiloxane having at least two silicon-bonded hydrogen atoms in one molecule, and a platinum-based catalyst.

An example of a condensation reaction curable composition is one comprising: an organopolysiloxane having at least two silicon-bonded hydroxyl groups (silanol groups) in one molecule, an organopolysiloxane having at least two silicon-bonded hydrogen atoms in one molecule, and an organotin-based catalyst.

An example of a peroxide curable composition is one comprising: an organopolysiloxane having at least two alkenyl groups in one molecule and an organic peroxide.

Moreover, examples of high-energy beam curable compositions are a ultraviolet-curable composition comprising: an organopolysiloxane having acrylic groups or methacrylic groups and a photosensitization agent; a ultraviolet-curable composition comprising: an organopolysiloxane having epoxy groups and an onium salt catalyst; a ultraviolet-curable composition comprising: an acrylic-modified organopolysiloxane obtained by Michael addition of a polyfunctional acrylic monomer and an amino group-containing organopolysiloxane, and a photosensitizer; and further, an electron beam curable composition.

An example of a method for forming a silicone-based cured product layer on a release film is the method whereby a base film is coated by the above-mentioned curable silicone-based composition, and then the composition is cured. Examples of coating methods are the direct gravure, Mayer bar, air knife, offset gravure, wire bar, and multi-step roll coating methods. Moreover, when the composition is used for coating after dilution, preferably a solvent such as toluene is used for diluting the composition. In this case, preferably the curable silicone-based composition is diluted to 1 to 20 mass %.

The amount of curable silicone-based composition used for the coating varies with the base film, but is preferably 0.1 to 4 g/m², particularly 0.5 to 2 g/m², in terms of solid component. This is because using too much composition for the coating is uneconomical, while using too little composition for the coating results in parts that are not coated (about a size of a pin hole). The thickness of the silicone-based cured product layer formed on the base film in this manner is not particularly restricted, but is preferably within a range of 0.1 to 10 μm.

With regard to the method for curing the curable silicone-based composition coated on the base film, curing can be promoted by heating when the composition is an addition reaction curable composition, condensation reaction curable composition, or peroxide curable composition, while curing can be promoted by exposure to high-energy beams such as X rays, electron beams, or ultraviolet light when the composition is a high-energy beam curable composition.

Next, the compression molding method of the present invention will be described in detail.

The compression molding method of the present invention is a method for compression molding a sealing material or reflective frame material of an optical semiconductor element, or a lens, by feeding a release film between a top mold and a bottom mold and then feeding a molding material, characterized in that the above-mentioned release film is used as the release film.

In the compression molding method of the present invention, first, the release film is fed between a top mold and a bottom mold facing each other. Preferably, the release film is automatically fed by a release film feed mechanism. Examples of the release film feed mechanism is one formed from a feed-side roll and a take up-side roll. Moreover, in the molding method of the present invention, either the top mold or the bottom mold may have a concave cavity for molding. Note that, in FIGS. 3 and 6, the concave cavity for molding is formed in the bottom mold 5. The release film fed from the release film feed mechanism (not illustrated) is fed such that the surface having the silicone-based cured product layer will make contact with the molding material. Note that preferably, the release film is caused to bond to the top mold or bottom mold by an air suction mechanism. FIGS. 3 and 6 are cross-sectional drawings of partially broken views showing the condition before the molding material is fed. LED chips face, such that they are aligned with, the position of the concave cavity in the bottom mold 5. Note that in FIG. 3, the release film 3 is fed between the top mold 4 and the bottom mold 5, and is caused to bond to the concave cavity in the bottom mold 5 by an air suction mechanism (not illustrated) disposed in the bottom mold 5. Moreover, in FIG. 6, the release film is further fed between a substrate 6 on which the LED chips are mounted and the top mold, and is caused to bond to the top mold 4 by an air suction mechanism (not illustrated) disposed in the top mold 4.

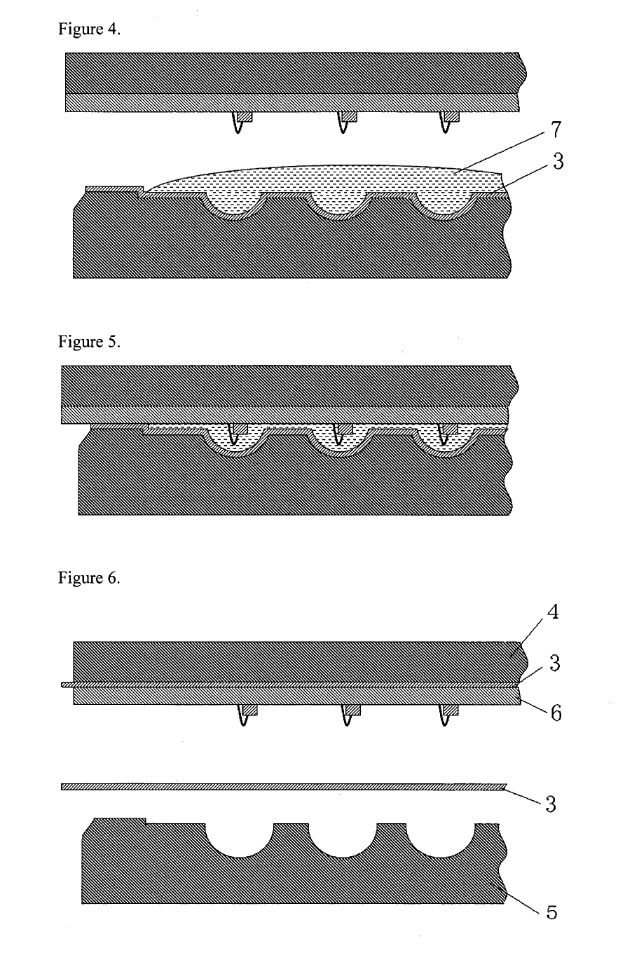

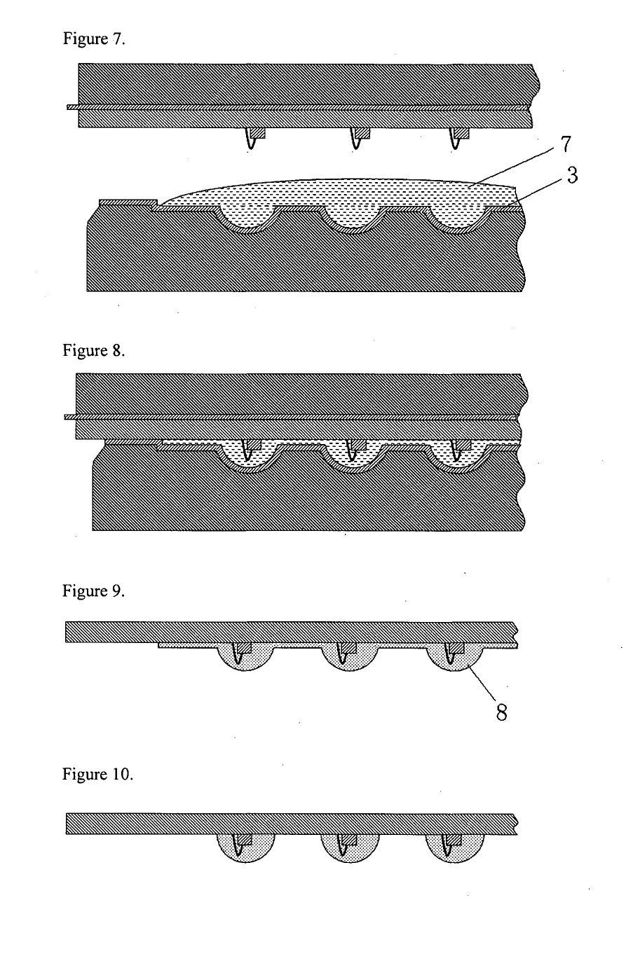

Next, a molding material is fed to the concave cavity part. Preferably, the molding material is automatically fed by a molding material feed device. FIGS. 4 and 7 are cross-sectional drawings of partially broken views showing the condition immediately after a molding material 7 has been fed to the bottom mold 5 covered by the release film 3.

Next, the top mold 4 and the bottom mold 5 are closed and the molding material 7 can be cured and molded by heating. FIGS. 5 and 8 are cross-sectional drawings of partially broken views showing the condition when the molding material 7 is molded. By pressure bonding the substrate 6 to the bottom mold 5, it is possible to interpose the release film 3 and to form a reliable seal at the periphery of the sealing region and prevent the molding material 7 from leaking.

Although molding conditions are not particularly limited, for example, heating is preferably performed at 50 to 200° C., and particularly 100 to 150° C., for 0.5 to 60 minutes, and particularly 1 to 30 minutes.

Moreover, the molded product is removed after compression molding and, when necessary, secondary curing (post-curing) can be performed for 0.5 to 4 hours at 150 to 200° C.

Preferably, in the compression molding method of the present invention, a step for molding a molding material, a step for opening the top mold and the bottom mold and removing the molded product, and a step for taking up the used release film to the take up-side roll while feeding unused release film between the top and the bottom mold using a release film feed mechanism comprising a feed-side roll and a take up-side roll are performed as a series.

FIGS. 9 and 10 are cross-sectional drawings of partially broken views showing an optical device molded together with a silicone convex lens 8 as a single unit. According to this method, it is possible to simultaneously resin seal multiple optical semiconductor elements mounted on the substrate and sealing operation efficiency can therefore be improved. In FIGS. 9 and 10, multiple LED chips are mounted, but it is possible to produce individual optical devices by cutting the substrate using a dicing saw, laser, and the like.

The molded product formed by the compression molding method of the present invention can be an optical member such as a lens or an optical waveguide, a sealing member of an optical semiconductor element such as a light emitting element or a light-receiving element, or a light-reflecting member such as an optical semiconductor element. The molded product can be a transparent molded product or an opaque molded product that contains a fluorescent substance, and the like. The shape of the molded product is not particularly limited. Examples are a convex lens shape, concave lens shape, Fresnel lens shape, truncated cone shape, or square cone platform, but a convex lens shape is preferred.

Next, the compression molding apparatus of the present invention will now be described.

The compression molding apparatus of the present invention is a compression molding apparatus comprising: a top mold, a bottom mold, a release film feed mechanism and a molding material feed mechanism, characterized in that the above-mentioned release film is used as the release film fed to inside the mold by the release film feed mechanism.

As shown in FIGS. 3 and 6, the top mold 4 and the bottom mold 5 are disposed facing one another, and either the top mold or the bottom mold has a concave cavity for molding. In FIGS. 3 and 6, the concave cavity is formed in the bottom mold 5. The top mold 4 and the bottom mold 5 are molds heated by respective heaters (not illustrated).

The compression molding apparatus of the present invention has a release film feed mechanism for feeding a release film 3 between the top mold 4 and the bottom mold 5. Preferably, the release film feed mechanism is formed from a feed-side roll and a take up-side roll. In FIG. 3, the release film feed mechanism is disposed on the bottom mold side in order to feed release film to the bottom mold 5 side, but in FIG. 6, it is necessary to dispose the release film feed mechanism on the top mold 4 side as well in order to also feed release film to the top mold 4 side.

When a sealing material for an optical semiconductor element is molded by the compression molding apparatus of the present invention, a substrate on which optical semiconductor elements are mounted is supported by the mold facing the mold in which the concave cavities for molding have been formed. In FIGS. 3 and 6, the substrate 6 on which optical semiconductor elements are mounted is supported by the top mold 4. Moreover, when a reflective frame material of an optical semiconductor element is molded by the compression molding apparatus of the present invention, a substrate for mounting the optical semiconductor elements is similarly supported by the mold facing the mold in which the concave cavity for molding has been formed.

According to the compression molding apparatus of the present invention, the release film fed between the top mold 4 and the bottom mold 5 needs to be fed such that the surface having the silicone-based cured product layer makes contact with the molding material. Note that, preferably, the top mold 4 or the bottom mold 5 has an air suction mechanism for causing the release film 3 fed from the release film feed mechanism to bond to the mold. This air suction mechanism acts during molding to cause the release film to bond to the cavity and, by blowing air, acts after molding to facilitate peeling of the release film from the mold and facilitate removal of the molded product. Furthermore, preferably, there is a middle plate between the top mold and the bottom mold. By raising and lowering the middle plate, this middle plate acts to force the release film to the mold and promote the effect of causing bonding to the cavity, and the effect of smoothing out the wrinkles in the release film.

In the compression molding apparatus of the present invention, preferably, there is a molding material feed device for feeding molding material in the concave cavity part. A quantitative dispenser and the like can be used as the molding material feed device.

In the compression molding apparatus of the present invention, preferably, there is an air suction mechanism for defoaming the molding material inside the mold when the top mold and the bottom mold are closed and the molding material is compression molded. The formation of voids in the molded product can be prevented by this air suction mechanism.

In addition, in the compression molding apparatus of the present invention, preferably, there is a mechanism by which operations for taking up used release film on the take up-side roll while feeding unused release film between the top mold and the bottom mold are performed as a series by a release film feed mechanism comprising a feed-side roll and a take up-side roll when, after the molding material has been molded, the top mold and the bottom mold are opened and the molded product is removed. A compression molding device having such a mechanism can be obtained as the FFT1005 manufactured by TOWA Corporation, and the like.

### EXAMPLES

The release film, compression molding method, and compression molding apparatus of the present invention will now be described in detail with reference to practical examples. Note that the viscosity in the practical examples is the value at 25° C.

### Practical Example 1

An addition reaction curable silicone composition was prepared by mixing 100 parts by mass of a raw rubber-like copolymer of dimethylsiloxane and methylhexenylsiloxane capped at both molecular terminals with trimethylsiloxy groups (hexenyl group content: 0.5 wt %), 2 parts by mass of methylhydrogenpolysiloxane having a viscosity of 150 mPa·s, a complex of chloroplatinic acid and 1,3-divinyltetramethyl disiloxane (at an amount such that the amount of platinum metal was 200 ppm), 1 part by mass of 3-methyl-1-butyn-3-ol, and 1,957 parts by mass of toluene.

A PET film having a silicone-based cured product layer with a thickness of 4 μm was prepared by coating a PET film (T-100, manufactured by Mitsubishi Plastics, Inc.) having a thickness of 38 μm with the addition reaction curable silicone composition using a bar coater such that the amount of coating would be 0.5 g/m², and then forming a cured layer by heating the product for 30 seconds at 140° C. in a circulating hot air oven.

### Practical Example 2

An addition reaction curable silicone composition was prepared by mixing 100 parts by mass of a raw rubber-like copolymer of dimethylsiloxane and methylhexenylsiloxane capped at both molecular terminals with trimethylsiloxy groups (hexenyl group content: 0.5 wt %), 2 parts by mass of methylhydrogenpolysiloxane having a viscosity of 150 mPa·s, a complex of chloroplatinic acid and 1,3-divinyltetramethyl disiloxane (at an amount such that the amount of platinum metal was 200 ppm), 1 part by mass of 3-methyl-1-butyn-3-ol, and 1,957 parts by mass of toluene.

A polyimide film having a silicone-based cured product layer with a thickness of 4 μm was prepared by coating a polyimide film (Kapton (registered trademark) 100H, manufactured by Toray Industries, Inc.) having a thickness of 25 μm with the addition reaction curable silicone composition using a bar coater such that the amount of coating would be 0.5 g/m², and then forming a cured layer by heating the product for 30 seconds at 140° C. in a circulating hot air oven.

### Practical Example 3

17.16 g of isobutyl alcohol and 21.3 g of a mixture of dipentaerythritol hexacrylate (60 mass %) and dipentaerythritol(monohydroxy)pentacrylate (40 mass %) were added to a flask and stirred. Then 0.46 g (amount of amino groups: 0.001 mol) of amino-modified dimethylpolysiloxane represented by the following average molecular formula:

NH₂C₃H₆Me₂SiO(Me₂SiO)₉SiMe₂C₃H₆NH₂

is added and the product was heated to 50° C. and stirred for one hour to obtain a reaction mixture. Next, 5.30 g of 3-methacryloxypropyl trimethoxysilane, 53.3 g of an IPA dispersion of colloidal silica (concentration: 30 mass %; colloidal silica average particle size: 13 nm), and 0.48 g of water were added to this in succession and stirred for one hour. After cooling, 2.00 g of photoinitiator (Irgacure 184, manufactured by BASF) and 4.3 mg of phenothiazine were added and a high-energy beam curable silicone composition having a solution viscosity of 8 mm²/s was prepared.

A PET film (T-100, manufactured by Mitsubishi Plastics, Inc.) having a thickness of 38 μm was coated with the high-energy beam curable silicone composition using a bar coater and the product was dried for 3 minutes at 80° C. Then, the coating was cured by being exposed to 1,000 mJ/cm² ultraviolet light to prepare a PET film having a silicone-based cured product layer with a thickness of 4 μm.

### Practical Example 4

A PET film having on both sides a silicone cured product layer with a thickness of 4 μm was prepared by coating the surface opposite the surface having a silicone cured product layer of the release film prepared in Practical Example 1 with the addition reaction curable silicone composition and curing the composition in the same manner as in Practical Example 1.

### Reference Example 1

### Preparation of Silicone-Modified Epoxy Resin Molding Material

A transparent silicone-modified epoxy resin molding material was prepared from a curable epoxy-modified silicone composition obtained by uniformly mixing 5.96 g of an epoxy-modified silicone resin (epoxy equivalent: 299; viscosity: 13.4 Pa·s; mass average molecular weight: 2,600) represented by the average unit formula:

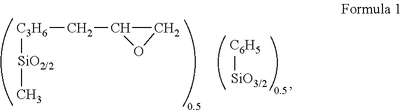

6.04 g of 3,4-epoxycyclohexenylmethyl-3′,4′-epoxycyclohexene carboxylate (Celoxide 2021P, manufactured by Daicel Chemical Industries Ltd.), 11.16 g of 3- or 4-methyl-hexahydrophthalic anhydride (HN 5500E, manufactured by Hitachi Chemical Co., Ltd.), and 0.194 g of methyltributylphosphonium dimethylphosphonate (Hishicolin PX-4 MP, manufactured by Nippon Chemical Industrial Co., Ltd.).

### Reference Example 2

### Preparation of Epoxy Resin Molding Material

A transparent epoxy resin molding material was prepared from a curable epoxy resin composition obtained by uniformly mixing 10.07 g of 3,4-epoxycyclohexenylmethyl-3′,4′-epoxycyclohexene carboxylate (Celoxide 2021P, manufactured by Daicel Chemical Industries Ltd.), 12.93 g of 3- or 4-methyl-hexahydrophthalic anhydride (HN 5500E, manufactured by Hitachi Chemical Co., Ltd.), and 0.188 g of methyltributylphosphonium dimethylphosphonate (Hishicolin PX-4 MP, manufactured by Nippon Chemical Industrial Co., Ltd.).

### Practical Example 5

The FFT1005 manufactured by TOWA Corporation was used as the compression molding machine consisting of a top mold and a bottom mold, having a concave cavity in the bottom mold, and having a release film feed mechanism on the bottom mold side. A glass epoxy substrate was disposed on the top mold of the compression molding machine. The mold of the bottom mold had 100 concave cavities/1 shot, and the metal mold of the top mold was flat. Next, the release film prepared in Practical Example 1 was fed on top of the bottom mold by the release film feed mechanism and bonded to the concave cavity in the bottom mold by air suctioning. On this release film, 1.4 mL of addition reaction curable silicone-based sealing material (Dow Corning (registered trademark) OE-6370HF, manufactured by Dow Corning Toray Co., Ltd.; type A durometer hardness of cured product: 70; refractive index: 1.41) was coated, the top mold and the bottom mold were brought together with the substrate interposed in between, and compression molding was performed for 5 minutes under a load of 3 MPa at 120° C. Then, the resin-sealed substrate was removed from the mold and heat treated for one hour in a 150° C. oven. The surface of the molded product was smooth without voids, appearance and filling performance were good, 100 molded products adhered to the substrate, and release from the release film was smooth. Moreover, release of the release film from the mold was also good.

### Practical Example 6

A resin-sealed substrate was produced in the same manner as Practical Example 5 except that an addition reaction curable silicone-based sealing material (Dow Corning (registered trademark) OE-6636, manufactured by Dow Corning Toray Co., Ltd.; type D durometer hardness of cured product: 33; refractive index: 1.54) was used in place of the addition reaction curable silicone-based sealing material (OE-6370HF, manufactured by Dow Corning Toray Co., Ltd.) used in Practical Example 5. The surface of the molded product was smooth without voids, appearance and filling performance were good, 100 molded products adhered to the substrate, and release from the release film was smooth. Moreover, release of the release film from the mold was also good.

### Practical Example 7

A resin-sealed substrate was produced in the same manner as Practical Example 5 except that compression molding was performed for 8 minutes at a molding temperature of 140° C. using the silicone-modified epoxy resin molding material prepared in Reference Example 1 in place of the addition reaction curable silicone-based sealing material (OE-6370HF, manufactured by Dow Corning Toray Co., Ltd.) used in Practical Example 5. The surface of the molded product was smooth without voids, appearance and filling performance were good, 100 molded products adhered to the substrate, and release from the release film was smooth. Moreover, release of the release film from the mold was also good.

### Practical Example 8

A resin-sealed substrate was produced in the same manner as Practical Example 5 except that an addition reaction curable silicone-based sealing material (Dow Corning (registered trademark) EG-6301, manufactured by Dow Corning Toray Co., Ltd.; type A durometer hardness of cured product: 71; refractive index: 1.41) was used in place of the addition reaction curable silicone-based sealing material (OE-6370HF, manufactured by Dow Corning Toray Co., Ltd.) used in Practical Example 5. The surface of the molded product was smooth without voids, appearance and filling performance were good, 100 molded products adhered to the substrate, and release from the release film was smooth. Moreover, release of the release film from the mold was also good.

### Practical Example 9

A resin-sealed substrate was produced in the same manner as Practical Example 5 except that an addition reaction curable silicone-based sealing material (Dow Corning (registered trademark) JCR6125, manufactured by Dow Corning Toray Co., Ltd.; type A durometer hardness of cured product: 23; refractive index: 1.41) was used in place of the addition reaction curable silicone-based sealing material (OE-6370HF, manufactured by Dow Corning Toray Co., Ltd.) used in Practical Example 5. The surface of the molded product was smooth without voids, appearance and filling performance were good, 100 molded products adhered to the substrate, and release from the release film was smooth. Moreover, release of the release film from the mold was also good.

### Practical Example 10

A resin-sealed substrate was produced in the same manner as Practical Example 5 except that compression molding was performed for 8 minutes at a molding temperature of 140° C. using the epoxy resin molding material prepared in Reference Example 2 in place of the addition reaction curable silicone-based sealing material (OE-6370HF, manufactured by Dow. Corning Toray Co., Ltd.) used in Practical Example 5. The surface of the molded product was smooth without voids, appearance and filling performance were good, 100 molded products adhered to the substrate, and release from the release film was smooth. Moreover, release of the release film from the mold was also good.

### Practical Example 11

A resin-sealed substrate was produced in the same manner as Practical Example 5 except that the release film used was a release film prepared in Practical Example 2 and an addition reaction curable silicone-based sealing material (Dow Corning (registered trademark) OE-6662, manufactured by Dow Corning Toray Co., Ltd.; type D durometer hardness of cured product: 65; refractive index: 1.53) was used in place of the addition reaction curable silicone-based sealing material (OE-6370HF, manufactured by Dow Corning Toray Co., Ltd.) used in Practical Example 5. The surface of the molded product was smooth without voids, appearance and filling performance were good, 100 molded products adhered to the substrate, and release from the release film was smooth.

Moreover, release of the release film from the mold was also good.

### Practical Example 12

A resin-sealed substrate was produced in the same manner as Practical Example 5 except that the release film used was a release film prepared in Practical Example 3 and an addition reaction curable silicone-based sealing material (Dow Corning (registered trademark) OE-6662, manufactured by Dow Corning Toray Co., Ltd.; type D durometer hardness of cured product: 65; refractive index: 1.53) was used in place of the addition reaction curable silicone-based sealing material (OE-6370HF, manufactured by Dow Corning Toray Co., Ltd.) used in Practical Example 5. The surface of the molded product was smooth without voids, appearance and filling performance were good, and although some of the 100 molded products did not adhere to the substrate, release from the release film was smooth. Moreover, release of the release film from the mold was also good.

### Comparative Example 1

A resin-sealed substrate was produced in the same manner as Practical Example 5 except that a PET film having a thickness of 38 μm was used in place of the release film prepared in Practical Example 1 used in Practical Example 5. None of the 100 molded products adhered to the substrate, but adhered to the release film. Note that there were no difficulties with releasing the release film from the mold.

### Comparative Example 2

A resin-sealed substrate was produced in the same manner as Practical Example 5 except that an ethylene-tetrafluoroethylene copolymer resin (ETFE) film (Aflex LM, manufactured by Asahi Glass Co., Ltd.) having a thickness of 25 μm was used in place of the release film prepared in Practical Example 1 used in Practical Example 5. The surface of the molded product was smooth without voids, and appearance and filling performance were good. However, the film showed a tendency toward deformation by the heat from the mold, showed a tendency toward wrinkling, and was difficult to handle. Moreover, the film tore under tension when released from the mold and the molded product was therefore difficult to remove.

### Comparative Example 3

A resin-sealed substrate was produced in the same manner as Practical Example 11 except that a polyimide film (Kapton (registered trademark) 100H, manufactured by Toray Industries, Inc.) having a thickness of 25 μm was used in place of the release film prepared in Practical Example 2 used in Practical Example 11. None of the 100 molded products adhered to the substrate, but adhered to the release film. Note that there were no difficulties with releasing the release film from the mold.

### INDUSTRIAL APPLICABILITY

The release film of the present invention has good workability and has good molded product releasability of molding materials. Therefore, the release film of the present invention is suitably used for producing an optical semiconductor element with good efficiency by compression molding.

### DESCRIPTION OF SYMBOLS

1 Base film
2 Silicone-based cured product layer
3 Release film
4 Top mold
5 Bottom mold
6 Substrate on which optical semiconductor element has been mounted
7 Molding material
8 Lens

1. A release film for interposing between a molding material and a mold when the molding material is compression molded using the mold to form a sealing material or reflective frame material for an optical semiconductor element, or a lens, wherein the release film comprises a silicone-based cured product layer on at least a surface in contact with the molding material.

2. The release film according to claim 1, wherein a base film of the release film is formed from polyolefin, polybutylene terephthalate, polyethylene terephthalate, polyamide, polycarbonate, polyvinylidene chloride, polystyrene, polyvinyl alcohol, polyimide, or a mixture thereof.

3. The release film according to claim 1, wherein the silicone-based cured product layer is formed from a curable silicone-based composition that is addition reaction curable, condensation reaction curable, peroxide curable, high-energy beam curable, curable by addition reaction and condensation reaction, curable by addition reaction and high-energy beams, or curable by condensation reaction and high-energy beams.

4. The release film according to claim 1, wherein the molding material is a silicone-based material.

5. The release film according to claim 4, wherein the silicone-based material is a curable silicone composition or a curable epoxy-modified silicone composition.

6. A compression molding method for compression molding a sealing material or reflective frame material of an optical semiconductor element, or a lens, the method comprising the steps of: feeding a release film between a top mold and a bottom mold, and feeding a molding material, wherein the release film is the release film as claimed in claim 1.

7. A compression molding apparatus for molding a sealing material or reflective frame material of an optical semiconductor element, or a lens, the device comprising: a top mold, a bottom mold, a release film feed mechanism, and a molding material feed mechanism, wherein the release film mechanism is configured to feed a release film into the mold, wherein the release film is the release film as claimed in claim 1.

8. The release film according to claim 2, wherein the base film of the release film has a thickness within a range of 10 to 100 μm.
